(19) United States
(12) Patent Application Publication
(10) Pub. No.: US 2025/0319592 A1
(43) Pub. Date: Oct. 16, 2025

(54) METHOD FOR OPTIMIZING ROBOT MOVEMENT PATH

(71) Applicant: ABB SCHWEIZ AG, Baden (CH)

(72) Inventors: Dingli Bao, Shanghai (CN); Changnian Qian, Shanghai (CN); Lei Mao, Shanghai (CN); Xiaodi Yu, Shanghai (CN)

(21) Appl. No.: 19/250,649

(22) Filed: Jun. 26, 2025

Related U.S. Application Data
(63) Continuation of application No. PCT/CN2023/073387, filed on Jan. 20, 2023.

(51) Int. Cl. B25J 9/16

(52) U.S. Cl. CPC B25J 9/1664

(57) ABSTRACT

A method for obtaining a target path of a robot includes obtaining a plurality of points of an original path of the robot; determining, among the plurality of points, a first set of points to be included in the target path of the robot and a second set of points to be excluded from the target path; and determining the target path by determining, based on the first set of points and the second set of points, at least one sub-path of the target path as linear or circular.

### FIELD

Embodiments of the present disclosure generally relate to the field of robot movement path, and more specifically, relate to a method for optimizing robot movement path.

### BACKGROUND

Robots are widely used in various industries. The movement path of a robot is important for the robot to finish the work appropriately. For example, in the teeth mold cutting industry, a robot is required to cut useful parts from a teeth mold. The source point set is in general provided by the customer. However, one set usually has 300 to 800 points. The dense points will cause the robot wobbling and heavy socket communication load. These issues are also existed in other applications e.g., precision machining and carving.

However, in order to find the best fitness, it will take too much time to calculate all the solutions and it will delay the application runtime. Apart from the start point, linear movement needs one more point and circular movement needs two more points. If there are total n points sent from a robot application, the overall permutation time complexity is (n−1)! in order to find the best fitness.

The combination of linear movement and circular movement shall meet two aspects: less distance error and less break point number. However, the two aspects are conflicted with each other. If the path has more break points, it will have less error and more fitness. However, in some fields, for example in the application of cutting teeth mold, the number of points needs to be deducted, in order to mitigate the wobbling of the robot, and meanwhile, to make sure the accuracy of the robot path. Currently, there is no optimization method to find the best combination of linear movement and circular movement under a given distance error.

Therefore, there is a need in the art for optimizing robot movement path in an efficient way.

### SUMMARY

In view of the foregoing problems, example embodiments of the present disclosure propose a method for optimizing robot movement path by using linear and circular movement in an efficient way.

In a first aspect of the present disclosure, a method for obtaining a target path of a robot is provided. The method comprises: obtaining a plurality of points of an original path of the robot; determining, among the plurality of points, a first set of points to be included in the target path of the robot and a second set of points to be excluded from the target path; and determining the target path by determining, based on the first set of points and the second set of points, at least one sub-path of the target path as linear or circular. With the technical features of the embodiments of the present disclosure, an original path of the robot can be divided into a plurality of sub-paths and each of the plurality of sub-paths can be determined in an efficient way. And then, the plurality of sub-paths can form an optimized target path.

In some embodiments, determining the at least one sub-path as linear or circular comprises: determining a first error based on a point of the second set of points and a sub-path in the event that the sub-path is a linear sub-path; determining a second error based on the point and the sub-path in the event that the sub-path is a circular sub-path; and determining the sub-path as linear or circular by comparing the first error and the second error. With the technical features of the embodiments of the present disclosure, points that are excluded from the target path can used to determine errors, in order to judge whether the target path is optimized.

In some embodiments, determining the first error comprises: determining a distance from the point to a line of the linear sub-path in three-dimensional space. With the technical features of the embodiments of the present disclosure, by determining a distance between a point and a linear sub-path, an error can be better determined.

In some embodiments, determining the second error comprises: determining a distance from the point to an arc of the circular sub-path in three-dimensional space. With the technical features of the embodiments of the present disclosure, by determining a distance between a point and a circular sub-path, an error can be better determined.

In some embodiments, the method further comprises: determining the linear sub-path by selecting a first point from the first set of points as a start point of the linear sub-path and a second point from the first set of points as an end point of the linear sub-path. With the technical features of the embodiments of the present disclosure, by determining the linear sub-path, an error can be better determined.

In some embodiments, the method further comprises: determining the circular sub-path by selecting a first point from the first set of points as a start point of the circular sub-path, a second point from the first set of points as a middle point of the circular sub-path, and a third point from the first set of points as an end point of the circular sub-path. With the technical features of the embodiments of the present disclosure, by determining the circular sub-path, an error can be better determined.

In some embodiments, determining the first set of points and the second set of points comprises: determining the first set of points and the second set of points by performing a genetic algorithm. With the technical features of the embodiments of the present disclosure, a genetic algorithm can be used to optimize the path.

In some embodiments, wherein determining the target path comprises: determining the target path along with the first set of points and the second set of points by performing the genetic algorithm. With the technical features of the embodiments of the present disclosure, a genetic algorithm can be used to optimize the path.

In some embodiments, performing the genetic algorithm comprising: determining, based on the plurality of points, a gene structure, at least one target, at least one constrain, a group number, and an iteration condition of the genetic algorithm for obtaining the target path; and obtaining the target path based on the gene structure, the at least one target, the at least one constrain, the group number, and the iteration condition. With the technical features of the embodiments of the present disclosure, a genetic algorithm with several parameters can be used to optimize the path.

In some embodiments, obtaining the target path comprises: determining a preliminary path based on the gene structure, the at least one target, the at least one constrain, the group number, and the iteration condition; and performing a post-processing on the preliminary path to obtain the target path. With the technical features of the embodiments of the present disclosure, a genetic algorithm with several parameters can be used to optimize the path.

In some embodiments, determining the gene structure comprises: determining a first node value, a second node value and a third node value of a gene in the gene structure, wherein the first node value stands for a point in the second set of points, the second node value stands for a start point for a linear sub-path, the third node value stands for a start point for a circular sub-path, and the length of the gene is the number of points. With the technical features of the embodiments of the present disclosure, a genetic algorithm with several parameters can be used to optimize the path and the status of each point can be determined.

In some embodiments, the at least one target comprises: minimizing the number of break points and a maximum error associated with the second set of points, wherein a break point is a point between a linear sub-path and a circular sub-path. With the technical features of the embodiments of the present disclosure, a genetic algorithm can be used to optimize the path and the target of the genetic algorithm can be determined.

In some embodiments, the at least one constrain comprises: a first point and a last point among the plurality of points are in the first set of points; and a minimum of the maximum error associated with the second set of points is set by an application requirement. With the technical features of the embodiments of the present disclosure, a genetic algorithm can be used to optimize the path and the constrain of the genetic algorithm can be determined.

In some embodiments, performing the post-processing comprises: based on determining that there is no first node value before the third node value, converting the third node value to the second node value. With the technical features of the embodiments of the present disclosure, a genetic algorithm can be used to optimize the path, and by post-processing, a better fitness of a path can be determined.

In some embodiments, the plurality of points comprises n points, and wherein determining the first set of points and the second set of points comprises: determining a first linear error based on a (m−1)th point and a linear sub-path including a (m−2)th point and a mth point; determining a first circular error based on: the (m−1)th point and a circular sub-path including a (m−3)th point, the (m−2)th point and the mth point; or the (m−2)th point and a circular sub-path including the (m−3)th point, the (m−1)th point and the mth point; and determining the (m−1)th point is in the second set of points based on determining that the first linear error or the first circular error is less than or equal to a predetermined threshold, wherein 1<m≤n. With the technical features of the embodiments of the present disclosure, a dynamic process can be used to optimize the path and a point can be determined as a filtered point.

In some embodiments, the method further comprises: if the first linear error or the first circular error is greater than the predetermined threshold, determining a second linear error based on the (m−1)th point and a linear sub-path including a (m−3)th point and a mth point, and a (m−2)th point and a linear sub-path including a (m−3)th point and a mth point, or determining a second circular error based on: the (m−1)th point and a circular sub-path including a (m−4)th point, the (m−3)th point and the mth point, and the (m−2)th point and a circular sub-path including a (m−4)th point, the (m−3)th point and the mth point, or the (m−2)th point and a circular sub-path including the (m−4)th point, the (m−1)th point and the mth point, and the (m−3)th point and a circular sub-path including the (m−4)th point, the (m−1)th point and the mth point, or the (m−3)th point and a circular sub-path including the (m−4)th point, the (m−2)th point and the mth point, and the (m−1)th point and a circular sub-path including the (m−4)th point, the (m−2)th point and the mth point; and determining the (m−1)th point is in the second set of points if the second linear error or second first circular error is less than the predetermined threshold. With the technical features of the embodiments of the present disclosure, a dynamic algorithm can be used to optimize the path and a point can be determined as a filtered point.

In some embodiments, the method further comprises: if a (m−1)th linear error and a (m−1)th circular error is greater than the predetermined threshold, determining the (m−1)th point is in the first set of points. With the technical features of the embodiments of the present disclosure, a dynamic algorithm can be used to optimize the path and a point can be determined as a target point.

In some embodiments, when m=n, the first set of points and the second set of points are determined. With the technical features of the embodiments of the present disclosure, a dynamic algorithm can be used to optimize the path and the process can be determined as being finished.

In some embodiments, determining the target path comprises: connecting the at least one sub-path. With the technical features of the embodiments of the present disclosure, an optimized path can be obtained.

In a second aspect of the present disclosure, a robot is provided. The robot comprises a computer readable storage medium having computer readable program instructions stored thereon which, when executed by a processing unit, cause the processing unit to perform the above process. With the technical features of the embodiments of the present disclosure, a robot can obtain a path with better accuracy and less communication.

With the technical features of the embodiments of the present disclosure, a path of a robot can be determined with better accuracy and less communication, in which the path of the robot will have a better fitness and the distance error will never larger than the user setting. The command transmission and the communication load will be deducted. Fewer points will improve the robot wobbling, and thus, the robot wobbling is reduced.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1A schematically illustrates linear movement and circular movement of a robot according to some embodiments of the present disclosure.

FIG. 1B schematically illustrates a process for obtaining a target path of a robot according to some embodiments of the present disclosure

FIG. 2A schematically illustrates a movement path of a robot with filtered points according to some embodiments of the present disclosure.

FIG. 2B schematically illustrates a movement path of a robot without filtered points according to some embodiments of the present disclosure.

FIG. 3 schematically illustrates a process for dynamic programming according to some embodiments of the present disclosure.

FIG. 4 schematically illustrates points in the process for dynamic programming according to some embodiments of the present disclosure.

FIG. 5A schematically illustrates a movement path of a robot with filtered points according to some embodiments of the present disclosure.

FIG. 5B schematically illustrates a movement path of a robot without filtered points according to some embodiments of the present disclosure.

FIG. 6 schematically illustrates a movement path of a robot without optimization according to some embodiments of the present disclosure.

FIG. 7 schematically illustrates a process for optimizing robot movement path according to some embodiments of the present disclosure.

FIG. 8 schematically illustrates a movement path of a robot after optimization according to some embodiments of the present disclosure.

FIG. 9 schematically illustrates points in the process for dynamic programming according to some embodiments of the present disclosure.

FIG. 10 schematically illustrates a process for optimizing robot movement path according to some embodiments of the present disclosure.

FIG. 11 schematically illustrates a movement path of a robot after optimization according to some embodiments of the present disclosure.

FIG. 12 schematically shows a robot according to some embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As described above, in order to find the best fitness of a robot movement path, it will take too much time to calculate all the solutions and it will delay the application runtime. Therefore, embodiments of the present disclosure propose a method for optimizing robot movement path by using linear and circular movement in an efficient way. The term “circular” used herein includes, but not limited to, a curved shape.

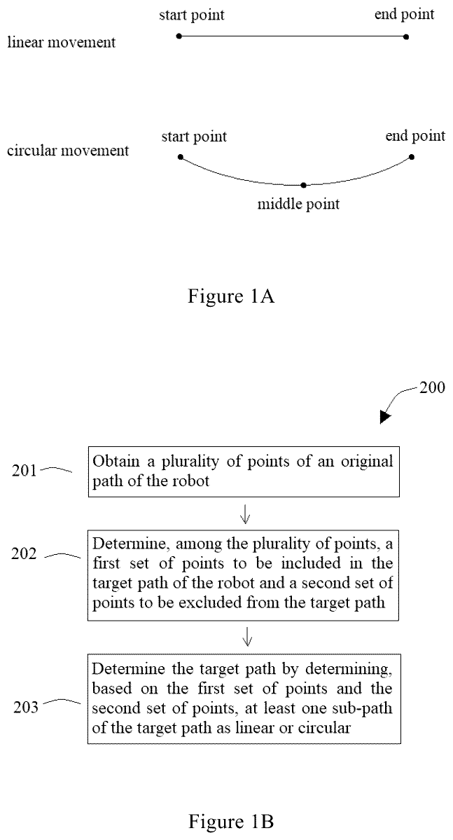

FIG. 1A schematically illustrates linear movement and circular movement of a robot according to some embodiments of the present disclosure. Linear movement and circular movement are the basic movement for robot. As shown in FIG. 1, linear movement needs 2 points: a start point and an end point; and circular movement needs 3 points: a start point, an end point and a middle point.

FIG. 1B schematically illustrates a process 100 for obtaining a target path of a robot according to some embodiments of the present disclosure, which is discussed below.

At block 101, the process obtains a plurality of points of an original path of the robot.

At block 102, the process determines, among the plurality of points, a first set of points to be included in the target path of the robot and a second set of points to be excluded from the target path.

At block 103, the process determines the target path by determining, based on the first set of points and the second set of points, at least one sub-path of the target path as linear or circular.

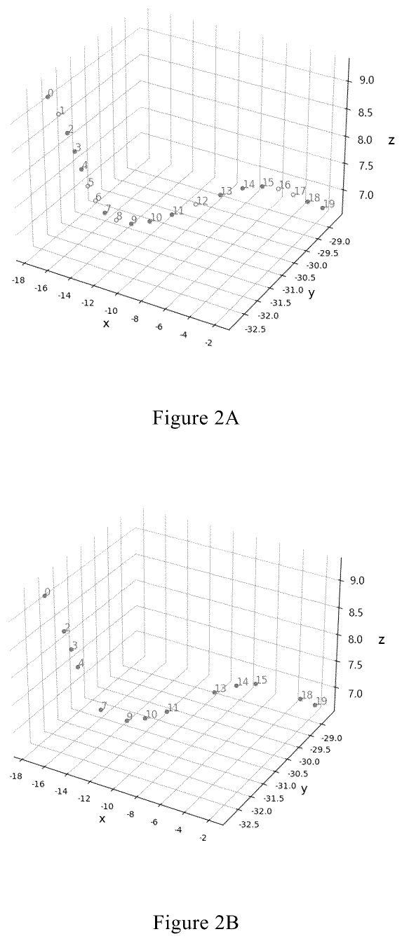

FIG. 2A schematically illustrates a movement path of a robot with filtered points according to some embodiments of the present disclosure. For example, 20 points are shown in FIG. 2A, and they are marked with numbers 0-19, respectively. In some embodiments, hollow points (e.g., points 1, 5, 6, 8, 12, 16 and 17) stand for a set of points to be excluded from a target path of the robot, which may be referred to as filtered points hereinafter. In some embodiments, the filtered point may be filtered by experienced methods. As shown in FIG. 2A, the solid points (e.g., points 0, 2, 3, 4, 7, 9, 10, 11, 13, 14, 15, 18 and 19) stand for a set of points to be included in the target path of the robot, which may be referred to as target points or key points hereinafter. These target points constitute the target path to be sent to a robot and of the robot may be controlled to finally follow the target path constituted by these target points. FIG. 2B schematically illustrates a movement path of a robot without filtered points according to some embodiments of the present disclosure. In FIG. 2B, the filtered points (points 1, 5, 6, 8, 12, 16 and 17) are omitted for demonstration purposes and the target points (points 0, 2, 3, 4, 7, 9, 10, 11, 13, 14, 15, 18 and 19) are remained. Linear movement is used for its simplicity. If a combination of linear and circular movement is used, it will have a smooth path and less wobbling.

According to some embodiments of the present disclosure, the overall path can be split into several sub-paths. Each sub-path needs to be only considered whether it shall be either linear movement or circular movement. Then, the process is recurred from the first point (start point) to the last point (end point). Finally, the best combination of linear movement and circular movement can be defined.

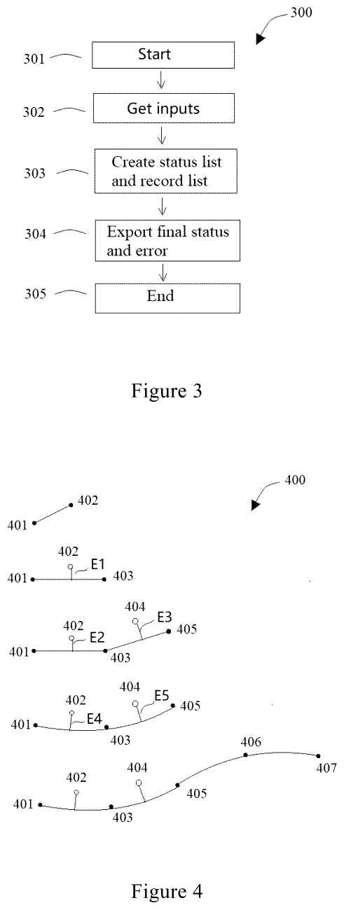

FIG. 3 schematically illustrates a process 300 for dynamic programming according to some embodiments of the present disclosure. The process 300 for optimizing robot movement path is a process of dynamic programming, which is discussed below.

At block 301, the process starts.

At block 302, the process gets inputs that include points list.

At block 303, the process creates a status list (dp) and a record list (dp_record). The status list (dp) is used to record the current best sum of the error. The record list (dp_record) is used to record the corresponding combination. The initial value of the status list is zero. At for the next step, the status list will record the accumulated error by the distance functions calculated with the filtered points.

The process 400 for the dynamic programming is shown in FIG. 4. In FIG. 4, a point 401 is for the first point, i.e., a start point. A point 402 is the second point. If the point 402 is the last point, i.e., an end point, the sub-path between the point 401 and the point 402 shall be a line. That is, the movement between the point 401 and the point 402 shall be linear movement.

If the point 402 is a filtered point determined, for example by experienced methods, which is used to calculate the distance from the filtered point to the line as an error. A first error E1 is recorded, which is for linear movement.

In FIG. 4, a point 403 is the third point, a point 404 is the fourth point, a point 405 is the fifth point, a point 406 is the sixth point, and a point 407 is the seventh point. In some embodiments, the fourth point 404 is filtered. As stated above, circular movement needs 3 points: a start point, an end point and a middle point. In other words, three points can constitute circular movement. Then, for the first point 401, the third point 403 and the fifth point 405 (the second point 402 and the fourth point 404 are filtered) as shown in FIG. 4, there may be two situations. One situation is that the first point 401 and the third point 403 constitutes a line and the third point 403 and the fifth point 405 constitutes another line (two linear movement), in which the errors are a second error E2 and a third error E3. The other situation is that the first point 401, the third point 403 and the fifth point 405 constitutes a curve (circular movement), in which the errors are a fourth error E4 and a fifth error E5.

In the situation of two linear movements, the fifth point 405 is the second end point of line movement. In the situation of circular movement, the fifth point 405 is the first end point of the circular movement.

Then, the process may comprise comparing errors of the two situations to decide which one is optimal. In particular, the process calculates accumulated errors of the two situations, and compares which error is smaller. The situation with a smaller error will be the optimal one. In particular, if the situation in which two linear movements are included has a smaller error than the situation in which a circular movement is included, then the sub-path will be determined as linear, and vice versa. The process chooses the optimal situation and the error is recorded in the record list. Then the less error of the situation will be reserved and the error is recorded in the status list (dp). And in the record list (dp_record), the error may be recorded with symbol “L” for linear movement or symbol “C” for circular movement, depending on which has a smaller error.

In some embodiments, at least one of the first error or the second error may be determined by a distance from the point to a line in three-dimensional space or from the point to an arc in three-dimensional space.

Referring to FIG. 3 again, at block 304, the step in block 303 is repeated, until the last point.

At block 304, the final status with combination and error is exported, for example, to the robot.

At block 305, the process ends.

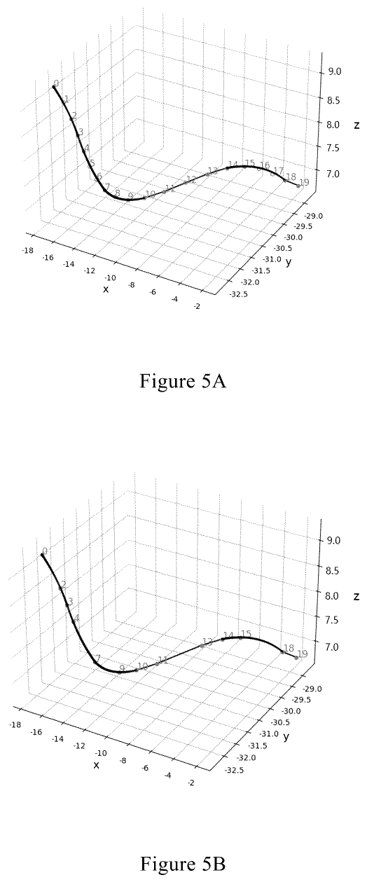

FIG. 5A schematically illustrates a movement path of a robot with filtered points according to some embodiments of the present disclosure. FIG. 5B schematically illustrates a movement path of a robot without filtered points according to some embodiments of the present disclosure. It can be seen from FIG. 5A and FIG. 5B, after optimization, the best combination for the points as shown in FIG. 2 is Circular [0,2,3], Circular [3,4,7], Circular [7,9,10], Linear [10,11], Linear [11,13], Linear [13,14], Circular [14,15,18] and Linear [18,19]. In a circular movement, the first number stands for the start point of the circular movement, the second number stands for the middle point of the circular movement, and the third number stands for the end point of the circular movement. Making Circular [0,2,3] as an example, the first number “0” stands for the start point of the circular movement, the second number “2” stands for the middle point of the circular movement, and the third number “3” stands for the end point of the circular movement. In a linear movement, the first number stands for the start point of the linear movement and the second number stands for the end point of the linear movement. Making Linear [10,11] as an example, the first number “10” stands for the start point of the linear movement and the second number “11” stands for the end point of the linear movement.

According to the experiment results, the sum of the error for all linear movement is 0.3 mm; and the sum of the error for the optimization is 0.15 mm, whose improvement is 50% for this case.

According to some embodiments of the present disclosure, the novel method of dynamic programming is introduced to search the best combination of linear movement and circular movement with less time consumption. In addition, the method according to the embodiments of the present disclosure can provide the best combination of linear and circular movement.

With the technical features of the embodiments of the present disclosure, since both linear movement command and circular movement command are used, the robot path will have a better fitness on the real path, especially for the corner. Therefore, a better accuracy can be achieved. Moreover, since the dynamic programming will deduct the optimization time consumption to get the best combination, less time consumption is required. Besides, the robot wobbling can be reduced since fewer points are involved.

Furthermore, according to some embodiments of the present disclosure, a robot may follow a path with best combination of commands regarding linear movement and circular movement.

Break point is the start or the end point of linear and circular movement. For example, before the break point, the movement can be a kind of movement (e.g., linear movement), and after the break point, the movement can be a different kind of movement (e.g., circular movement), vice versa. In other words, a break point is a point between a linear sub-path and a circular sub-path.

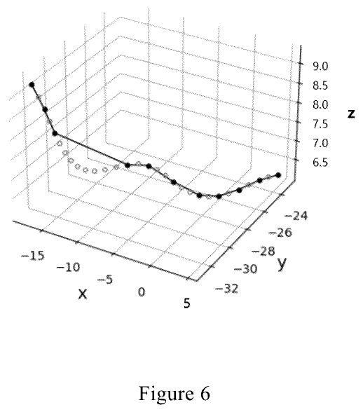

FIG. 6 schematically illustrates a movement path of a robot without optimization according to some embodiments of the present disclosure. In particular, FIG. 6 shows fitness with some break points. In the most cases, linear movement is the only command used due to its simplicity. Two points are linked and the points between the two points are used to calculate the distance errors based on the fitted line. If the errors are acceptable, then these points between the two points can be filtered to reduce the number of points. However, such fitness may not be optimal. It is hard to traverse all the combination. The points will have 3 statuses: filtered point, linear break point or circular break point. If there are n points, the time complexity is about O⁽³^{ⁿ⁻²}⁾. It will take too much time to derive the optimization.

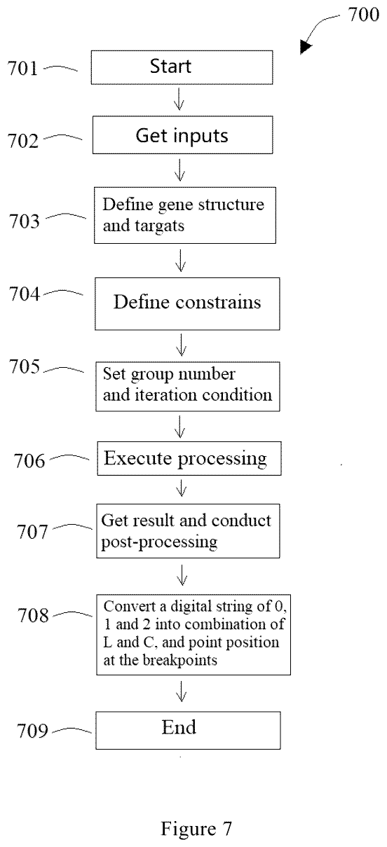

According to some embodiments of the present disclosure, a multi-target genetic process is introduced. FIG. 7 shows a process 700 for optimizing robot movement path, which is discussed below.

At block 701, the process starts.

At block 702, the process gets inputs (points).

At block 703, the process defines the gene structure and targets. A gene with 3 characters (node values) is created and the characters (node value) are 0, 1 and 2, in which 0 stands for filtered point; 1 stands for start point for linear movement; and 2 stands for start point for circular movement. The length of gene is the number of points. One target is the number of break points and another target is the maximum distance error per filtered points. Both targets shall get the minimum.

At block 704, the process defines constrains. For example, the first and last point cannot be 0. That is, the first and last point cannot be the filtered point. And the minimum of the maximum distance error per filtered points shall be set by the application requirement, such as 0.1 mm. The minimum number of break points shall be set, like one-third of the total number of points. It should be noted that too strict restrictions can result in no solution.

At block 705, the process set a group number and an iteration condition. For example, the group number may refer to the number of cases in each group in genetic algorithm. The iteration condition may refer to convergence condition. For example, the iteration condition may be the number of iteration, or the iteration condition may refer to meet some criterion, e.g., being lower than an error threshold.

At block 706, the process executes a processing, for example, by using a genetic algorism.

At block 707, the process gets the result and conducts post-processing. For example, if the node is 2 and there is no 0 node before 2, then convert 2 to 1.

At block 708, the process converts a digital string composed of 0, 1 and 2 into the combination of L and C, and the corresponding point position at the breakpoints.

At block 709, the process ends.

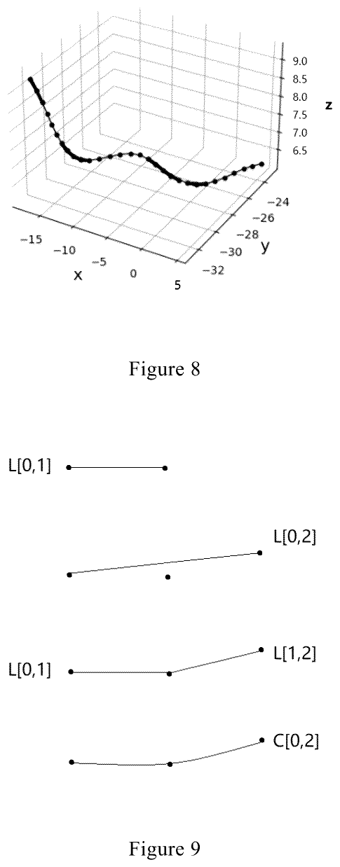

FIG. 8 shows a path with best combination of commands regarding linear movement and circular movement.

Furthermore, according to some embodiments of the present disclosure, a robot may follow a path with best combination of commands regarding linear movement and circular movement by introducing dynamic programming.

The process of dynamic programming according to some embodiments of the present disclosure creates a point list and a record list. The record list has the same length of the point list and starts from the first point. In each node, the best local optimization is recorded. In the middle node, it searches back one by one until the filtered point is not satisfied the distance error set previously. The circular movement is default one if both circular and linear movements are satisfied. The circular movement is more suitable for the arc path.

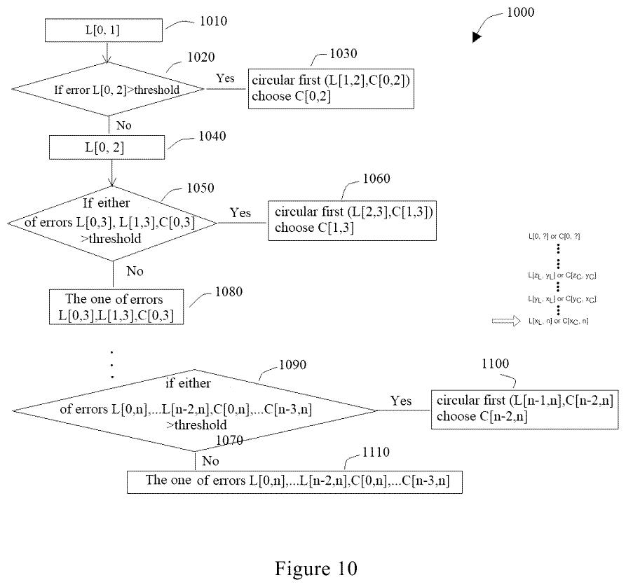

FIG. 9 shows the theory of the process of dynamic programming. FIG. 10 schematically illustrates a process 1000 for optimizing robot movement path according to some embodiments of the present disclosure. As shown in FIG. 9 and FIG. 10, the first 3 status based on the corresponding points are shown, in which L means linear movement and C means circular movement, and [0,1] means the start point position is 0 and the end point position is 1. L[0,1] must be a line, as shown in block 1010 in FIG. 10. For the third point, there are three situations: L[0,1], L[1,2] and C[0,2]. In the embodiments of FIG. 9, a circular movement may be represented with the start point and the end point (the middle point is omitted), for example, C[0,2].

As shown in FIG. 9 and FIG. 10, the middle point (second point) may be a filtered point, in this situation, L[0,2] shall be a line. In other words, the line is between the first point and the third point, and the second point is filtered. Then, the filtered second point is used to calculate the distance from the filtered point to the line as error. The error is recorded like L[0,2], which is for linear movement. In some embodiments, a threshold is introduced. The threshold is for example 0.05 mm. Then, the error L[0,2] is compared with the threshold, as shown in diamond 1020 in FIG. 10. If the error L[0,2] is not more than the threshold, the line is satisfied and it indicates that the second point can be filtered, and then the error L[0,2] is chosen, as shown in block 1040 in FIG. 10. However, if the error L[0,2] is more than the threshold, the line is not satisfied and it indicates that the second point cannot be filtered.

In the situation that the second point cannot be filtered, there are two possible situations. One is that there are two lines; the other is that there is a curve, as shown in FIG. 9. According to some embodiments of the present disclosure, the circular movement is default one. That is, the C[0, 2] is chosen, as shown in block 1030 in FIG. 10.

For the fourth point, five situations are considered: L[0,3], L[1,3], C[0,3], L[2,3] and C[1,3]. The middle points (second point and third point) may be filtered points. The potential filtered points are used to calculate the distance from the filtered points to the line as errors. The errors are recorded firstly like L[0,3], L[1,3], C[0,3]. Then, the errors L[0,3], L[1,3], C[0,3] are compared with the threshold one by one, as shown in diamond 1050 in FIG. 10. If either of errors L[0,3], L[1,3], C[0,3] is not more than the threshold, one of errors L[0,3], L[1,3], C[0,3] is satisfied and it indicates that the second point and/or the third point can be filtered, and then the one of errors L[0,3], L[1,3], C[0,3] is chosen, as shown in block 1080 in FIG. 10. However, if each of errors L[0,3], L[1,3], C[0,3] is more than the threshold, it is not satisfied and it indicates that the second point and/or the third point cannot be filtered. In the situation that the second point and/or the third point cannot be filtered, similarly, the circular movement is default one and C[1, 3] is chosen, as shown in block 1060 in FIG. 10.

The process can deduce the rest from this, until L[x_{L}, n] or C[x_{C}, n]. Position n is the last term. For the nth point, there are a plurality of situations and the errors are recorded firstly like L[0,n], . . . , L[n−2,n], C[0,n], . . . , C[n−3,n]. Then, the errors L[0,n], . . . , L[n−2,n], C[0,n], . . . , C[n−3,n] are compared with the threshold one by one, as shown in diamond 1090 in FIG. 10. If either of errors L[0,n], . . . , L[n−2,n], C[0,n], . . . , C[n−3,n] is not more than the threshold, one of errors L[0,n], . . . , L[n−2,n], C[0,n], . . . , C[n−3,n] is satisfied and it indicates that the corresponding point(s) can be filtered, and then the one of errors L[0,n], . . . , L[n−2,n], C[0,n], . . . , C[n−3,n] is chosen, as shown in block 1110 in FIG. 10. However, if each of errors L[0,n], . . . , L[n−2,n], C[0,n], . . . , C[n−3,n] is more than the threshold, it is not satisfied and it indicates that the corresponding point(s) cannot be filtered. In the situation that the corresponding point(s) cannot be filtered, similarly, the circular movement is default one and C[n−2,n] is chosen, as shown in block 1100 in FIG. 10.

Then, the process traces the path from the last sub-path to the first sub-path. For example, if the last diamond 1090 gets the result as [x_{L}, n] or C[x_{C}, n], then the process uses x_{L} or x_{C} as the end point to find the previous sub-path. The previous sub-path is [y_{L}, x_{L}] or C[y_{C}, x_{C}]. Next, the process uses y_{L} or y_{C} as the position to find the previous sub-path, and so on, until the starting point of the first sub-path is 0. For example, if the result in diamond 1090 is C[1,3], then the local combination is L[0,1] C[1,3].

The process combines all the sub-path and records it to the n position. Since n is the last position, the status at position n is the best combination for all the point.

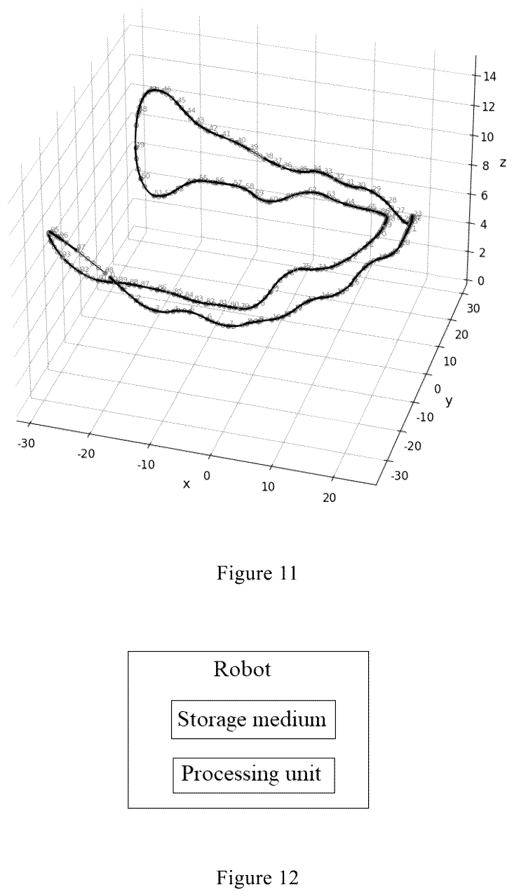

FIG. 11 shows an example for a teeth mold from 300 points to 88 points. Filtered points are marked as hollow points. There are circular movement and linear movement. For example, there are 300 original position points for the teeth mold cutting path. The process can optimize the points from 300 to 88 with the maximum error as 0.05 mm. The maximum error is set by user. FIG. 11 shows a great optimization to deduct the point number which ensures the accuracy as well. The time consumption for this case is near 10 s.

FIG. 12 schematically shows a robot according to some embodiments of the present disclosure. The robot comprises a computer readable storage medium having computer readable program instructions stored thereon which, when executed by a processing unit, cause the processing unit to perform the above process.

With the technical features of the embodiments of the present disclosure, the following effects are achieved: better accuracy: robot path will have a better fitness and the distance error will never larger than the user setting; less communication: the command transmission and the communication load will be deducted; and reduce of the robot wobbling: fewer points will improve the robot wobbling.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A method for obtaining a target path of a robot, comprising:
obtaining a plurality of points of an original path of the robot;
determining, among the plurality of points, a first set of points to be included in the target path of the robot and a second set of points to be excluded from the target path; and
determining the target path by determining, based on the first set of points and the second set of points, at least one sub-path of the target path as linear or circular.

2. The method of claim 1, wherein determining the at least one sub-path as linear or circular comprises:
determining a first error based on a point of the second set of points and a sub-path in the event that the sub-path is a linear sub-path;
determining a second error based on the point and the sub-path in the event that the sub-path is a circular sub-path; and
determining the sub-path as linear or circular by comparing the first error and the second error.

3. The method of claim 2, wherein determining the first error comprises:
determining a distance from the point to a line of the linear sub-path in three-dimensional space.

4. The method of claim 2, wherein determining the second error comprises:
determining a distance from the point to an arc of the circular sub-path in three-dimensional space.

5. The method of claim 2, further comprising:
determining the linear sub-path by selecting a first point from the first set of points as a start point of the linear sub-path and a second point from the first set of points as an end point of the linear sub-path.

6. The method of claim 2, further comprising:
determining the circular sub-path by selecting a first point from the first set of points as a start point of the circular sub-path, a second point from the first set of points as a middle point of the circular sub-path, and a third point from the first set of points as an end point of the circular sub-path.

7. The method of claim 1, wherein determining the first set of points and the second set of points comprises:
determining the first set of points and the second set of points by performing a genetic algorithm.

8. The method of claim 7, wherein determining the target path comprises:
determining the target path along with the first set of points and the second set of points by performing the genetic algorithm.

9. The method of claim 7, wherein performing the genetic algorithm comprising:
determining, based on the plurality of points, a gene structure, at least one target, at least one constrain, a group number, and an iteration condition of the genetic algorithm for obtaining the target path; and
obtaining the target path based on the gene structure, the at least one target, the at least one constrain, the group number, and the iteration condition.

10. The method of claim 9, wherein obtaining the target path comprises:
determining a preliminary path based on the gene structure, the at least one target, the at least one constrain, the group number, and the iteration condition; and
performing a post-processing on the preliminary path to obtain the target path.

11. The method of claim 9, wherein determining the gene structure comprises:
determining a first node value, a second node value and a third node value of a gene in the gene structure, wherein the first node value stands for a point in the second set of points, the second node value stands for a start point for a linear sub-path, the third node value stands for a start point for a circular sub-path, and the length of the gene is the number of points.

12. The method of claim 9, wherein the at least one target comprises:
minimizing the number of break points and a maximum error associated with the second set of points, wherein a break point is a point between a linear sub-path and a circular sub-path.

13. The method of claim 9, wherein the at least one constrain comprises:
a first point and a last point among the plurality of points are in the first set of points; and
a minimum of the maximum error associated with the second set of points is set by an application requirement.

14. The method of claim 10, wherein performing the post-processing comprises:
based on determining that there is no first node value before the third node value, converting the third node value to the second node value.

15. The method of claim 1, wherein the plurality of points comprises n points, and wherein determining the first set of points and the second set of points comprises:
determining a first linear error based on a (m−1)th point and a linear sub-path including a (m−2)th point and a mth point;
determining a first circular error based on:
the (m−1)th point and a circular sub-path including a (m−3)th point, the (m−2)th point and the mth point; or
the (m−2)th point and a circular sub-path including the (m−3)th point, the (m−1)th point and the mth point; and
determining the (m−1)th point is in the second set of points based on determining that the first linear error or the first circular error is less than or equal to a predetermined threshold,
wherein m is greater than 1 and less than or equal to n.

16. The method of claim 15, further comprising:
based on determining that the first linear error or the first circular error is greater than the predetermined threshold,
determining a second linear error based on the (m−1)th point and a linear sub-path including a (m−3)th point and a mth point, and a (m−2)th point and a linear sub-path including a (m−3)th point and a mth point, or
determining a second circular error based on:
the (m−1)th point and a circular sub-path including a (m−4)th point, the (m−3)th point and the mth point, and the (m−2)th point and a circular sub-path including a (m−4)th point, the (m−3)th point and the mth point, or
the (m−2)th point and a circular sub-path including the (m−4)th point, the (m−1)th point and the mth point, and the (m−3)th point and a circular sub-path including the (m−4)th point, the (m−1)th point and the mth point, or
the (m−3)th point and a circular sub-path including the (m−4)th point, the (m−2)th point and the mth point, and the (m−1)th point and a circular sub-path including the (m−4)th point, the (m−2)th point and the mth point; and
determining the (m−1)th point is in the second set of points based on determining that the second linear error or second first circular error is less than the predetermined threshold.

17. The method of claim 16, further comprising:
based on determining that a (m−1)th linear error and a (m−1)th circular error is greater than the predetermined threshold, determining the (m−1)th point is in the first set of points.

18. The method of claim 17, wherein when m is equal to n, the first set of points and the second set of points are determined.

19. The method of claim 18, wherein determining the target path comprises:
obtaining the target path based on a set of sub-paths associated with the first set of points determined when m is equal to n.

20. A device for a robot, comprising:
at least one processor; and
at least one memory coupled to the at least one processor and having instructions stored thereon, wherein the instructions cause the at least one processor to perform the method of claim 1 when executed by the at least one processor.

21. A computer readable storage medium having computer readable program instructions stored thereon which, when executed by a processing unit, cause the processing unit to perform the method of claim 1.
